(19) United States
(12) Patent Application Publication
(10) Pub. No.: US 2010/0301266 A1
(43) Pub. Date: Dec. 2, 2010

(54) Coal Topper Dust Control Formulation, System and Method

(75) Inventors: Llyod W. Marsden, Sheridan, WY (US); Richard T. Bilodeau, Dayton, WY (US)

Correspondence Address: MERCHANT & GOULD PC, P.O. BOX 2903, MINNEAPOLIS, MN, 55402-0903, US

(73) Assignee: Rantec Corporation, Ranchester, WY (US)

(21) Appl. No.: 12/791,371

(22) Filed: Jun. 1, 2010

Related U.S. Application Data
(60) Provisional application No. 61/182,949, filed on Jun. 1, 2009.

(51) Int. Cl. C09K 3/22

(52) U.S. Cl. 252/88.1

(57) ABSTRACT

This disclosure describes formulations, systems and methods for coal topping, a term which refers to the application of liquid products to the top of coal loads, such as those in open topped coal hopper railcars as commonly used today to transport coal. Disclosed herein are controlled viscosity fluid formulations suitable for use as a coal topper. The fluids include water as a base solvent, polymer and, optionally, crosslinking agents and plasticizer. The polymer is a water-soluble polymer with reactive groups capable of producing viscosity in the solvent and reacting with crosslinking agents and the plasticizer. The polymer is one capable of manipulation to produce appropriate viscosity levels on a consistent basis. Crosslinking agents consist of chemicals capable of reacting with the reactive polymer to produce complexes that become essentially insoluble on drying. The plasticizer is an agent capable of providing for a dried matrix with flexibility without loss of strength.

### RELATED APPLICATIONS

This application claims the benefit of U.S. Provisional Application No. 61/182,949, filed Jun. 1, 2009, which application is hereby incorporated by reference.

### INTRODUCTION

Fugitive dust is an environmental and health hazard. All types of dust including soil particles, industrial products, by-products and waste, coal dust, road dust and many others present hazards. The high speed transportation of coal by rail may cause loss of fine coal particles. Both train vibration and airspeed (from wind or due to the speed of train) can lift particles from exposed coal making them airborne and depositing them along the right-of-way and transporting them by wind considerable distances. Measurements of coal loss in transit from Montana and Wyoming mines to Midwest power plants have been estimated as 0.5 to 2% of the loads depending upon conditions.

In addition to environmental hazards, health hazards and product loss, coal dust lost during transportation can also damage transportation infrastructure. In May of 2005 unusually wet spring weather in the Powder River Basin occurred. Almost immediately afterward successive derailments occurred on Burlington Northern Santa Fe (BNSF), Union Pacific (UP) and Joint Lines.₇ Critical rail shipments of coal fuel were curtailed causing near emergency conditions. Investigation revealed that a combination of early thaw, weather events and critically, contamination of rail ballast by coal fines had caused road bed softening and movement. The instability of the railroad bed caused derailments. The cost of the derailments included significant repair and clean up costs as well as costs for alternative fuel supplies while the transportation line was repaired.

### Coal Topper Dust Control Formulation, System and Method

This disclosure describes formulations, systems and methods for coal topping, a term which refers to the application of liquid products to the top of coal loads, such as those in open topped coal hopper railcars as commonly used today to transport coal. Disclosed herein are controlled viscosity fluid formulations that can be applied to coal or other media by spraying and suitable for use as a coal topper. The fluids include water as a base solvent, polymer and, optionally, crosslinking agents and plasticizer. The polymer is a water-soluble polymer with reactive groups capable of producing viscosity in the solvent and reacting with crosslinking agents and the plasticizer. The polymer is one capable of manipulation to produce appropriate viscosity levels on a consistent basis. Crosslinking agents consist of chemicals capable of reacting with the reactive polymer to produce complexes that become essentially insoluble on drying. The plasticizer is an agent capable of providing for a dried matrix with flexibility without loss of strength.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1 shows a sample of experimentally determined relationships between temperature (in degrees F.), radiation depolymerization (in kiloGrays) and polymer concentration (in wt %).

FIG. 2 illustrates an embodiment of a continuous dry mixing system.

FIG. 3 illustrates an embodiment of a batch dry mixing system.

FIG. 4 illustrates an embodiment of a method of topping a railcar containing coal.

### DETAILED DESCRIPTION

There are several constraints that apply to coal topper formulations. A tensile strength high enough to resist cracking when subjected to shocks and wind during transport is preferred. For the same reason, greater flexibility is also preferred. Due to the cost of water, a low water requirement is preferred. A relatively higher depth of penetration, which is directly related to the viscosity of the coal topper formulation, is preferred to bind as much coal mass at the surface as possible. Viscosity is related to the ability of the polymer fluid to penetrate the surface of the subject media. In particular coal particulates, which have different wetting properties than normal soil or rock particulate, will reject fluid with excessive viscosity while accepting lower viscosity fluid. It is speculated that a hydrophobic mechanism may play a part, possible a result of the hydrocarbon interaction with the coal topper. In addition, the coal topper formulation must not inhibit the ability to unload or burn the coal. A coal topper should not excessively corrode the transport equipment such as the railcars or loading/unloading equipment.

After much experimentation, the inventors have identified controlled viscosity fluid formulations that can be applied to coal or other media by spraying suitable for use as a coal topper. Specifically, the viscosity of the formulation can be easily controlled and tailored in the field to address different coal characteristics will still meeting the water usage requirements. The fluids include water as a base solvent, polymer and, optionally, crosslinking agents and plasticizer. The polymer is a water-soluble polymer with reactive groups capable of producing viscosity in the solvent and reacting with crosslinking agents and the plasticizer. The polymer is one capable of manipulation to produce appropriate viscosity levels on a consistent basis. Crosslinking agents consist of chemicals capable of reacting with the reactive polymer to produce complexes that become essentially insoluble on drying. The plasticizer is an agent capable of providing for a dried matrix with flexibility without loss of strength.

One embodiment of the dust-mitigation coal topper formulation consists of an aqueous fluid containing polymer. The preferred polymer is guar gum—200 mesh powder. The viscosity of the polymer is adjusted by treatment with gamma radiation to achieve a viscosity of 40 to 140 cps at 1% concentration at application temperature. Prior to addition of polymer the water is treated with XL™ crosslinking agent consisting of a blend of one part glyoxal and two parts zirconium lactate (e.g., the DuPont product sold under the brand name TYZOR 217) at a rate of 30 to 50 parts XL™ crosslinking agent per 100 parts of polymer. For example, to 15 gallons of water (125.1-lb) a dose of 1.75-lb of polymer is to be added; prior to the polymer addition a dose of 0.70-lb of XL™ (40% of 1.75-lb of polymer) is added. In the embodiment, the guar gum polymer is added to the water at a rate of 0.70% to 1.4% by weight. A plasticizer, glycerin, is added at a rate of 0.5 to 5% by weight of the solution.

The above-described embodiment represents an experimentally determined ideal formulation. However, alternative embodiments may be used that vary from this ideal to account for differences in such things as cost, aggregate coal size, anticipated weather during transport, anticipated length of transport and target levels of dust control. The following table provides the ideal formulation, the preferred target ranges for the constituents of the coal topper formulation based on the ideal, the acceptable ranges for the constituents and a presumed effective range at which some effect on coal dust emissions can be achieved, all presented in terms of lb per railcar.

TABLE 1

| Coal Topper | Ideal | | Acceptable | Presumed |
|---|---|---|---|---|
| Formulation | (lb/ | Target Range | Range | Effective Range |
| Constituents | railcar) | (lb/railcar) | (lb/railcar) | (lb/railcar) |
| Water | 125 | 125 +/− 12.5 | 83-330 | 12.5-1250 |
| Guar Gum | 1.75 | 1.75 +/− 0.175 | 1-5 | 0.2-17.5 |
| Polymer | | | | |
| XL ™ | 0.7 | 0.7 +/− 0.07 | 0.2-2.5 | 0.1-10 |
| Crosslinker | | | | |
| Glycerin | 1.5 | 1.5 +/− 0.15 | 0.7-7 | 0.1-15 |
| Plasticizer | | | | |

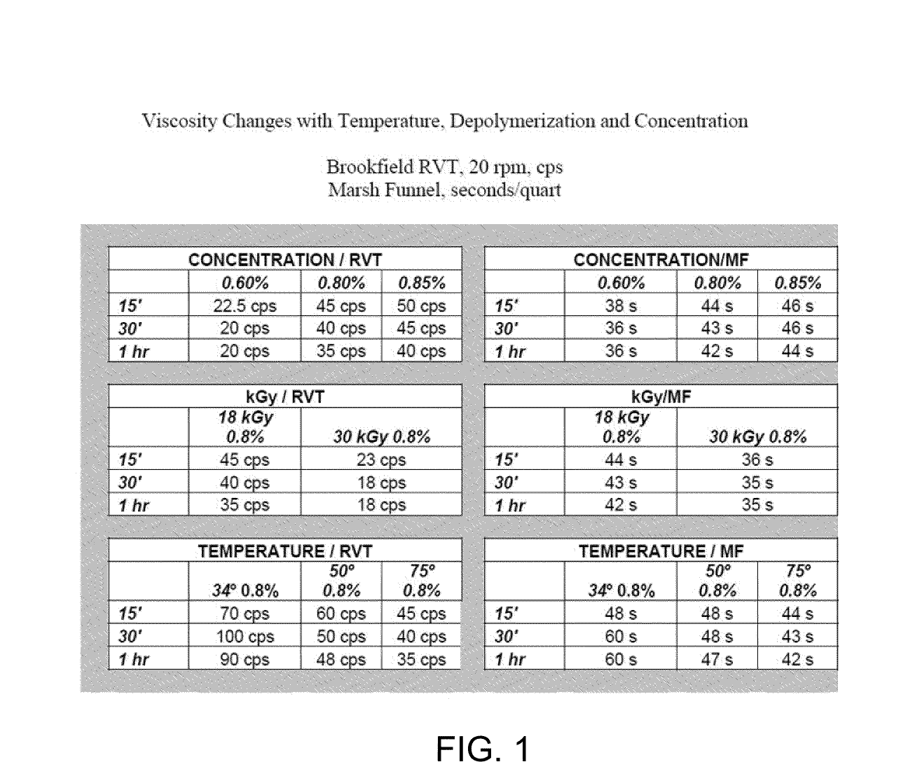

The resulting fluid is applied to the top of coal in railcars by spraying through one or more spray nozzles. In an embodiment the spray is sufficiently distributed to cover the exposed coal with a minimum of overspray. Viscosity of the fluid may be adjusted to 20 to 50 cps to account for temperature and other variables in the application process. FIG. 1 shows a sample of experimentally determined relationships between viscosity, time since mixing, temperature (in degrees F.), radiation depolymerization (in kiloGrays) and polymer concentration (in wt %). The entire fluid is mixed on a continuous basis with addition of polymer, crosslinker and plasticizer “on-the-fly” to achieve a continuous feed at the desired formulation and viscosity.

In alternative embodiments, the amount of polymer added can be varied to achieve any desired application viscosity, such as from 10 cps to 1000 cps. However, preferably, the depolymerization treatment of the polymer may be varied to achieve the desired application viscosity so that the amount of polymer used remains sufficiently high for the application purpose. For example, in an embodiment, initial testing may be used to identify a target range of needed viscosities based on variations in the field application conditions (temperature, etc.). The polymer may be then depolymerized so that any point within the target range can be easily achieved through variation of polymer amount in the field. In this embodiment, viscosity reduction from the native level of the polymer to an artificially-obtained, desired level is critical. Depolymerization may be achieved by enzymatic action, chemical action or by the controlled application of ionizing energy. The preferred method is the use of ionizing energy. Precise control of the viscosity end point of the coal topper formulation is more easily achieved by depolymerizing the polymer with ionizing energy to a known level before the mixing of the formulation, whereas the ability to consistently control the viscosity end point of the formulation is reduced with other methods.

In addition to the preferred constituents presented above, alternative polymers, crosslinkers, and plasticizers may be substituted to achieve effective alternative embodiments of the coal topper formulation.

### Examples of Suitable Polymers

The coal topper formulation consists of a primary polymer ingredient, supplemented in its performance with additives to modify characteristics and behavior. The polymer preferably provides 1) Viscosity, 2) Controlled Viscosity, 3) Adhesion when wet, 4) Adhesion and Cohesion when dry, 5) Chemical structure available for crosslinking to an insoluble state, 6) Becomes flexible with addition of plasticizer and 7) Economically feasible. Examples of suitable polymers include:

i. Guardian® Product—The controlled viscosity derivative of guar gum (i.e., depolymerized guar gum).

ii. Guar gum—The powder derived from the endosperm of cyamopsis tetragonoloba.

iii. Polyacrylamide—Polymer and/or co-polymer of acrylic monomer, acrylic acid or polyacrylate. Charge may be anionic, cationic or non-ionic.

iv. CMC—Carboxymethylated cellulose.

v. Starch—Derived from any plant source including corn, wheat, potato, tapioca and others.

vi. Other hydroxyl bearing polymers and gums.

vii. Mixtures of two or more of the above listed polymers.

Other polymers, including polymers not yet developed, may also be suggested to those of skill in the art and their application rates and effectiveness relative to the polymers explicitly listed above may be determined by one of skill in the art through experimentation using this specification as a guide.

Table 2 lists some alternative polymers and ranges of concentration for coal topper use.

TABLE 2

| | Acceptable | Presumed |
|---|---|---|
| Alternative | Range | Effective Range |
| Polymers | (lb/railcar) | (lb/railcar) |
| Starch | 1-25 | 0.1-250 |
| Polyacrylamide | 0.1-5 | 0.01-50 |
| and its co- | | |
| polymers | | |
| Carboxymethylated | 0.1-5 | 0.01-50 |
| Cellulose (CMC) | | |
| Psyllium Husck | 1-25 | 0.1-250 |
| Powder | | |
| Guar By-Products | 1-25 | 0.1-250 |

### Examples of Suitable Crosslinkers

The crosslinker is an optional constituent in the formulation. It serves to reduce the solubility of the polymer and is, therefore, helpful in increasing the longevity of the dust reduction effects. In an embodiment, the crosslinker may be added depending on the anticipated/forecasted weather associated with the route of the railcar. No crosslinker could be applied if no rain is forecast and increasing amounts of crosslinker could be applied based on the amount of rain, snow and temperatures forecasted. Such an adjustment of the crosslinker amount based on the forecast could be done manually by the operator, such as every day, or be automated by providing the forecasts to the control system (e.g., through a continuous or periodic download of forecast and route information) and providing an algorithm in the control system for adjusting the crosslinker amount automatically.

In an embodiment, the chosen polymer becomes essentially insoluble on drying through the addition of metal crosslinkers and/or alcohol or aldehyde. Combinations of crosslinking agents can prove to be more effective or economic while still achieving the desired level of insolubility. Crosslinking agents suitable for use are listed below. The agents may be selected based on experimentation to best suit the polymer or polymers used.

i. Metallic Crosslinkers

1. Borate—Chosen from the soluble and insoluble borate salts including, for example, sodium tetraborate and its hydrates, sodium Metaborate, and zinc Borate.

2. Zirconate—Typically aqueous or alcohol solutions of zirconium salts including zirconium lactate as presented in DuPont's TYZOR® 217.

3. Titanate—Aqueous and alcohol soluble salts of titanium alone or in conjunction with other agents provide crosslinked complexes.

4. Antimony—Typically Potassium Pyroantimonate or other soluble antimony salts.

5. Aluminum—Aluminum salts including aluminum sulfate, aluminum citrate, aluminum acetate and others crosslink and control the rate and time of crosslinking.

ii. Glyoxal and Aldehydes

1. Glyoxal. The addition of glyoxal may greatly enhance the performance of other crosslinking agents and performs alone.

ii. The group of aldehydes including urea formaldehyde for crosslinking of guar gum, starch and other hydroxyl bearing polymers may be useful. Aldehyde activation occurs or may improve with addition of salts for pH adjustment.

iii. Combinations of one or more products including XL™ crosslinker.

While above list consists of metallic, glyoxal and aldehyde crosslinkers, other crosslinking agents now known or later developed could potentially be substituted.

Table 3 lists some alternative crosslinkers and ranges of concentration for coal topper use.

TABLE 3

| | Acceptable | Presumed |
|---|---|---|
| Alternative | Range | Effective Range |
| Crosslinkers | (lb/railcar) | (lb/railcar) |
| Georgia Pacific | 0.05-1 | 0.001-10 |
| AmRes | | |
| Potassium | 0.005-0.1 | 0.001-1 |
| Pyrantimonate | | |
| Dimethyl-ol- | 0.0005-2 | Up to 10 |
| Urea and | | |
| Modifier | | |
| Borate | 0.001-0.01 | 0.0001-0.1 |
| Zirconate | 0.1-2.5 | 0.001-25 |
| Titanate | 0.1-2.5 | 0.001-25 |
| Aluminum | 0.1-2.5 | 0.001-25 |

### Examples of Suitable Plasticizers

The plasticizer is an optional constituent in the formulation. It serves to increase the flexibility of the polymer and is, therefore, helpful in increasing the longevity of the dust reduction effects. The increased flexibility prevents the crust (i.e., the surface layer of coal and polymer) from breaking and potentially falling from the railcar during transport. In an embodiment, the plasticizer may be added depending on the anticipated travel distance or time associated with the route of the railcar. To reduce costs no plasticizer could be applied to railcars with relatively short routes or travel times. Increasing amounts of plasticizer could be applied based on the length and time for a particular route. Such an adjustment of the plasticizer amount based on the route a railcar will travel could be done manually by the operator or be automated by providing the route information to the control system and providing an algorithm in the control system for adjusting the plasticizer amount automatically based on this information.

The plasticizer performs a function of providing flexibility on the molecular level that translates of matrix flexibility on the macro level. The plasticizer, in order to be effective in the system, cannot unduly reduce the strength of the matrix. Plasticizer is common in the plastics industry. For coal topping applications the material must be water-soluble and be compatible with the chosen polymer.

i. Glycerin and alcohols including ethylene glycol. In an embodiment, recovered glycerin, such as recovered de-icing fluid from airports could be used as a source of plasticizer. Because the plasticizer will ultimately be burned with the coal, it need not be pure and because it is used in such low concentrations, any trace contaminants do not represent a detriment to its usability. Another potential source of recovered chemical suitable as a plasticizer is recovered side release agent used on railcars to assist with the release of coal and other aggregates through the hopper car outlets.

ii. Fatty Acids

iii. Common Plasticizers in Plastics

Table 4 lists some alternative plasticizers and ranges of concentration for coal topper use.

TABLE 4

| | Acceptable | |
|---|---|---|
| Alternative | Range | Effective Range |
| Plasticizers | (lb/railcar) | (lb/railcar) |
| Polyethylene | 0.1-15 | 0.01-150 |
| Glycol | | |

### Viscosity Control

As mentioned above, viscosity control is an important feature for effective dust control and the ability to control viscosity is one of the features of the coal topper formulations presented herein. Viscosity affects the ability to deliver the formulation by affecting the ability to pump and spray apply a polymer containing fluid. The viscosity of the fluids affects flow rates and control is necessary for consistent application.

In addition, rapid penetration is required of the formulation so that a relatively thicker surface layer of the coal can stabilized. Fluids that do not penetrate the surface loaded coal will run off the coal, perhaps off the car and be wasted or can form an easily-separated crust or sheet on top of the coal. Penetration is controlled by viscosity and by wettability. For adequate penetration fluids should preferentially penetrate the coal surface to a distance necessary to form a matrix of adequate mass to prevent wind lifting of sheets. As viscosity increases the depth of penetration decreases. However, the limited amount of polymer and water in the fluid should be concentrated enough to form a fully bonded matrix as too much penetration by the fluid dilutes the polymer within the loaded coal.

The optimum viscosity is highly dependent on the amount of coal fines in the coal aggregate to be stabilized and the viscosity selected may be based on the amount of coal fines in the coal to be treated. In an embodiment, in order to determine a suitable viscosity to use, bench tests may be performed on each coal batch. Alternatively, the amount of coal fines may be quantified in any one of the ways known in the art and a viscosity selection made based on experimental correlation between the coal fines distribution and suitable penetration depth.

In an embodiment, viscosity is at least partially controlled through depolymerization of the polymer. Native viscosity of some of the most effective polymers such as guar gum, CMC and polyacrylamides is as much as 2 orders of magnitude too high for use in coal topping. At the water levels preferred (about 15-gallons/car) the native viscosity of these polymers is too high for effective penetration. In an embodiment, the primary viscosity reduction prior to any other control measures is done by reduction of the average polymer molecular weight or depolymerization. The following are examples of depolymerization methods that may be suitable:

i. Chemical—Chemical depolymerization may be accomplished by addition of softening agents such as strong alkalis followed by addition of oxidizing agents to break polymer bonds thereby reducing the average molecular weight of the polymer. Peroxide compounds may be utilized for this purpose. Control of the reaction is primarily done through reagent dosage and temperature. Exact control to achieve the necessary levels can be done.

ii. Energy—The use of energy sources such as electron beam or gamma radiation will break polymer chains. It is presumed that the process operates through generation of oxygen and hydrogen which in turn oxidize the polymer chain. Depolymerization of the chains stops immediately on cessation of energy exposure. Thus, the final viscosity of solutions of the polymer may be closely controlled. It is necessary to control the energy level based upon the initial polymer viscosity, granulation and moisture content. In addition the individual machine energy output must be measured in terms of its effect on the specific polymer.

iii. Mechanical—Although expensive, mechanical grinding may be used for depolymerization.

Viscosity control of the coal topper formulation can also be performed by controlling the temperature of the application. The proper viscosity of fluid to be applied is affected by the temperature of the fluid in an inverse relationship. The temperature of the coal or other subject media may change the temperature of the fluid on contact. The coal topper formulation's “in place” viscosity is controlled to supply the optimum viscosity for the temperature conditions on each loading. The ideal viscosity may be measured in field testing or determined through calculation based on known relationships.

Viscosity control of the coal topper formulation can also be performed by controlling the polymer concentration in the formulation. Most polymers including those of this formulation produce increasing viscosity with increasing concentration in the water solvent. The viscosity increase is generally much faster than linear. The corresponding decrease in viscosity on reduction of concentration is likewise non-linear. The “as applied” viscosity can be controlled within the parameters of water availability by adjusting the concentration of polymer.

Furthermore, viscosity of the formulation may be additionally controlled through the type and concentration of crosslinking agent. In addition, viscosity can be decreased through addition of the crosslinker prior to addition of the polymer. Conversely the viscosity increases with post addition of the crosslinker.

### Delivery Systems

Proper mixing sequence and equipment are necessary to produce consistent fluid suited to the application. In an embodiment, the preferred means is a continuous mixing system that feeds a sprayer under which the loaded coal cars are drawn at a preferably constant speed. In one embodiment, a continuous mixing system is used in which the constituents of the formulation are continuously added into a moving water stream which ends with the final formulation being sprayed on the surface of the coal cars. However, alternative mixing system embodiments may also be used. Many different systems are available for the application of liquids and any suitable equipment may be used. The following are two examples of existing technologies adapted for use with the coal topper formulation.

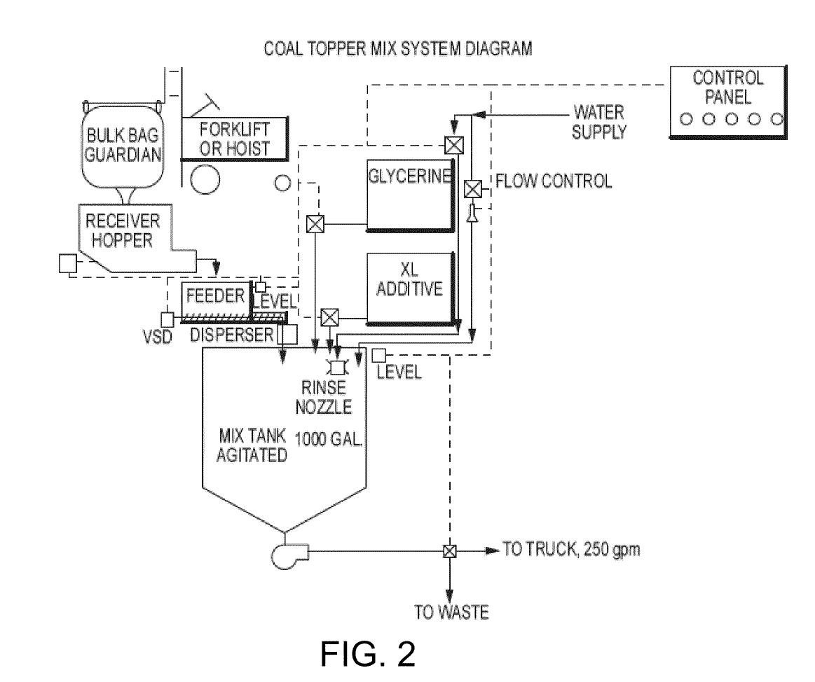

FIG. 2 illustrates an embodiment of a continuous mixing system. Continuous mixing eliminates the need for batching tanks and storage tanks. Dry polymer meters into a small mixing chamber or tank. Liquid additives flow into the same tank. Controllers maintain a set ratio of ingredients determined to provide the optimum fluid. In another embodiment, various monitoring devices may be used to regulate the addition of ingredients over time in order achieve specified viscosity and/or other properties in the resulting product when applied or discharged.

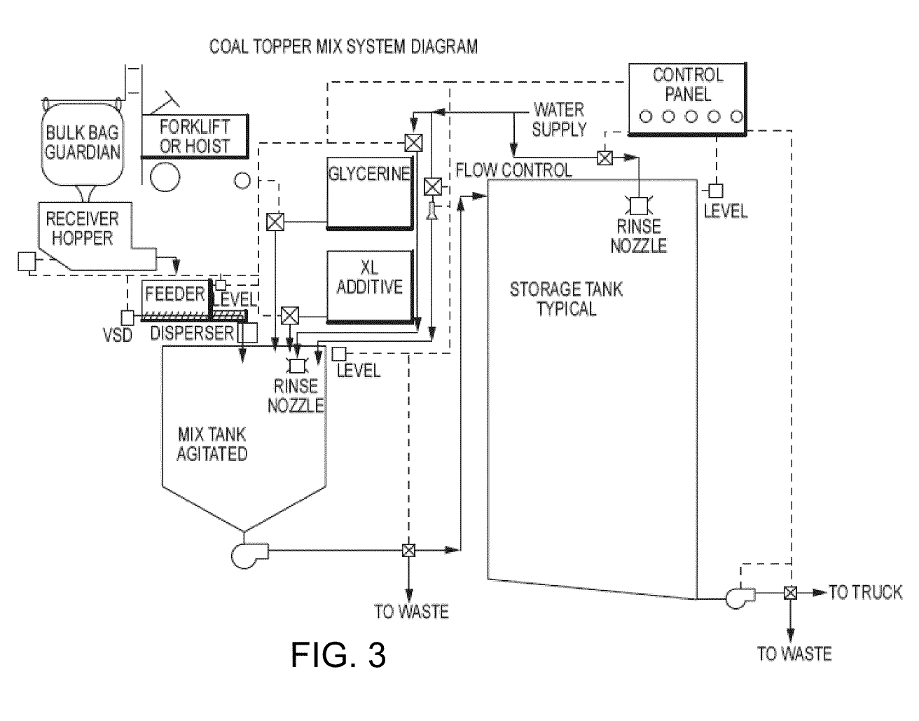

Other operations besides continuous mixing can be used. FIG. 3 illustrates an embodiment of a batch dry mixing system. In the batch dry mixing system a mixing sequence in which dry ingredients meter into the batch through dry feeders and liquid ingredients meter through liquid pumps. The completed batch flows to storage for aging to achieve the correct viscosity until drawn out to final use or transportation.

In the embodiments illustrated in FIGS. 2 and 3, each constituent of the coal topper formulation may be supplied by a different source (either in a liquid form or if feasible in a dry form as discussed below) to a mixing tank. Alternatively, two or more constituents may be combined in intermediate vessels or valves prior to being combined in the mixing tank. In yet another embodiment, one or more ingredients may be combined after the mixing tank, such as through the use of a venturi valve, in order to reduce the time between the mixing of the particular ingredients and the application to the coal.

In an embodiment, the output of the systems (referred to as “to Truck” in the FIGS.) are directly connected through piping to a distribution/application system such as a nozzle assembly that sprays the product directly onto the exposed surface of the coal. Alternatively the formulation may be mixed and transported to a final use site for application via an application system. In an application system, one or more shrouds or housings may be used to prevent overspray. Alternatively, the nozzles may be adjustable to fine-tune the application process. One or more pumps, manifolds, valves and control systems may be used in order to achieve the application of an amount effective in reducing the dust emissions. Furthermore, various monitors such as viscosity meters, temperature sensors, application rate monitors, conductance meters, pressure sensors and flow meters may be used to monitor and adjust the performance of the application system. Based on the data from the monitoring systems, the feed rates, mixing rates and other control parameters of the system may be adjusted to obtain the desired application results. The systems shown in FIGS. 2 and 3 represent example systems and other system configurations are possible.

Mixing systems need not utilize dry constituents. For example, slurried polymer could be used instead of dry polymer in either a batch or continuous system. Liquid mixtures of concentrated polymer provide for very easy metering and continuous mixing. Polymers mixed in non-solvent liquids will not activate or hydrate until contact with water. A range of fluids including mineral oil, diesel fuel, vegetable oil and some brines form good base fluids for carrying polymers. The polymer portion of the coal topper formulation can be delivered and mixed with water in such a liquid form. Water can, in some instances, be used as a carrier for a liquid polymer delivery system. Depolymerized polymers mixed in water achieve high concentrations without high viscosity development. Such mixtures transport well and may be utilized for field mixing. Use of slurried polymer allows the dry polymer addition to be moved to a well equipped permanent installation.

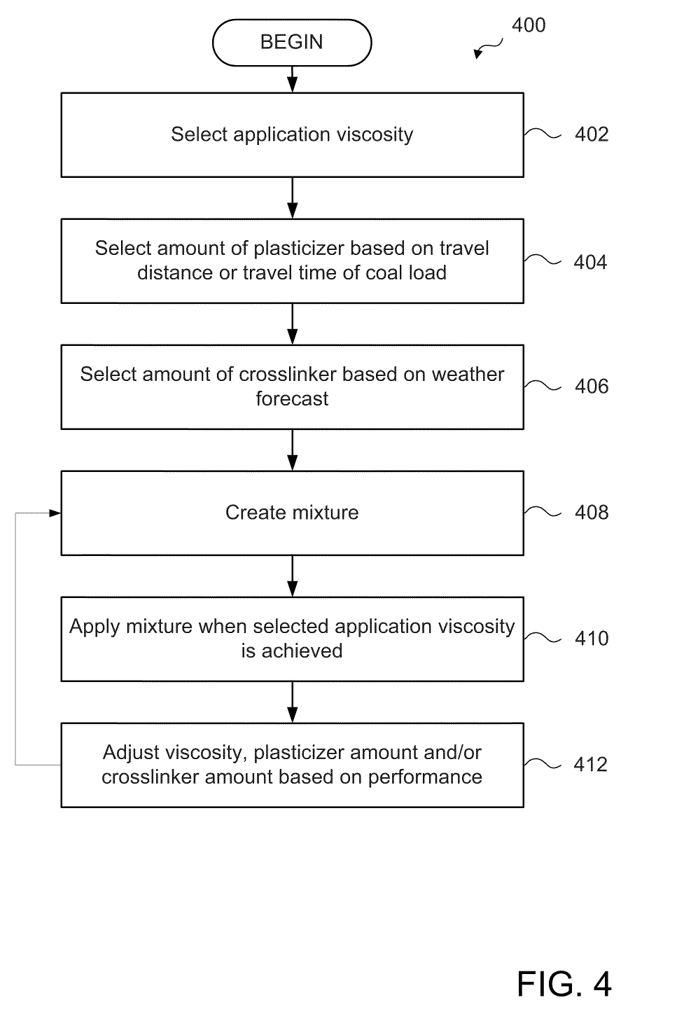

FIG. 4 illustrates an embodiment of a method of topping a railcar containing coal using the formulation described above. The method 400 starts with the selection of an application viscosity in a viscosity selection operation 402. As discussed above, selection of a particular viscosity for use with any given railcar or set of railcars can take into account many different factors including the amount of coal fines, the application temperature, and the particular application equipment. The viscosity may be selected after performing bench tests or in situ tests of the efficacy of different viscosities and polymers on the particular batch of coal, including analyzing different degrees of depolymerization and concentration of polymer. Alternatively or additionally, the amount and size distribution of fines can be determined and a viscosity may be selected based on that information.

In an embodiment, the viscosity selection operation 402 may be considered to also include a selection of the particular polymer or group of polymers and the application amount (such as pounds/railcar). For example, in an embodiment the polymer type and application may be selected based on prior experience or cost limitations and then the formulation viscosity at application necessary for proper penetration and adequate dust control performance may be determined based on bench or other testing, where the formulation viscosity at application is varied by through depolymerization of the polymer. In this embodiment, the viscosity selection operation 402 may be considered to include a polymer selection, a polymer application amount selection and a selection of a depolymerization level for the polymer necessary to achieve a target viscosity at application in which the target viscosity may be determined via testing or prior knowledge. In an alternative embodiment, the performance of different polymer(s) and application amount(s) may also be investigated to find the best combination of polymer, polymer concentration and application viscosity (hence depolymerization level of the polymer(s)).

For example, for any batch of coal selection may include choosing a polymer, identifying a level of depolymerization of the chosen polymer and then testing different concentrations of the depolymerized polymer to determine the best viscosity for the batch to achieve the desired penetration/dust suppression. The amount of depolymerization may be adjusted so that the necessary viscosity to achieve the desired dust suppression is obtained while also meeting the water usage constraints and the application time constraints (noting that viscosity will change over time so for any given formulation the time since mixing will also have an effect on the viscosity). In addition, if a range of application conditions are expected (e.g., variations in temperature), it may be desirable to vary the viscosity of the applied formulation within some target range based on those anticipated conditions. In this situation, the level of depolymerization may be selected to allow the viscosity to be easily adjusted in the field within the target range by varying the concentration of the depolymerized polymer.

A selection of the amount, if any, of plasticizer is also made as illustrated by the plasticizer selection operation 404. Again, as described above, the amount of plasticizer selected can take into account many different factors related to the length of travel time and/or transport distance for the particular railcar. Other factors may also be used such as type of plasticizer(s) used, route roughness (e.g., very hilly over rough tracks vs. very smooth), selected application viscosity, concentration of the polymer and crosslinker (if any), depth of penetration of the formulation/thickness of the crust formed on the surface of the coal, weather (e.g., forecasted wind speed) and past performance of formulations with different plasticizer levels.

A selection of the amount, if any, of crosslinker is also made as illustrated by the crosslinker selection operation 406. Again, as described above, the amount of crosslinker selected can take into account many different factors related to the forecasted weather and the need to decrease the solubility of the crust. Other factors may also be used such as type of crosslinker used, selected application viscosity, concentration of the polymer and plasticizer (if any), depth of penetration of the formulation/thickness of the crust formed on the surface of the coal, travel time, travel distance and past performance of formulations with different crosslinker levels.

After all the necessary amount selections have been made, the coal topper formulation is mixed, for example by using a mixing system such as those described in FIGS. 2 and 3. This is illustrated by the mixture creation operation 408.

The formulation is then applied to the railcar(s) at the selected viscosity, as illustrated by the application operation 410. This may require retaining the mixed formulation for a period of to allow the polymer to hydrate to the selected viscosity. Alternatively, the application system could be so designed that no retention is necessary and the formulation can be applied as soon as it is provided by the mixing equipment.

In the embodiment illustrated, feedback about the performance of particular formulations is received over time and the various selected amounts may be changed to optimize long term performance of the dust suppression method. This is illustrated by the adjustment operation 412.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope of the technology described herein. Numerous other changes may be made which will readily suggest themselves to those skilled in the art and which are encompassed in the spirit of the disclosure and as defined in the appended claims.

Although the techniques introduced above and discussed in detail below may be implemented for a variety of aggregates, the disclosure above discussed the implementation of the formulation and systems for a coal topper application. The reader will understand that the technology described in the context of a coal topper application could be adapted for use with other aggregate to reduce aggregate dust emissions during transport or storage.

What is claimed is:

1. A spray-applicable formulation for reducing the dust emissions from coal comprising:
a depolymerized guar gum polymer and water mixture having between 1 and 5 parts by weight guar gum polymer and 83 to 330 parts by weight water and having a viscosity from 40 to 140 cps when applied and at application temperature.

2. The formulation of claim 1 further comprising:
at least one plasticizer selected from glycerin, polyethylene glycol, fatty acids, and an alcohol.

3. The formulation of claim 2 wherein the plasticizer is glycerin, the polymer, water, plasticizer mixture having between 0.7 and 7 parts by weight glycerin.

4. The formulation of claim 2 wherein the concentration of plasticizer is selected at least in part based on a travel distance or travel time associated with the coal to which the formulation will be applied.

5. The formulation of claim 1 further comprising:
at least one crosslinker selected from glyoxal, an aldehyde, potassium pyrantimonate, dimethyl-ol-urea, a borate salt, a zirconium salt, a titanate salt, and a salt of aluminum.

6. The formulation of claim 5 wherein the crosslinker is of a blend of one part glyoxal and two parts zirconium lactate, the polymer, water, crosslinker mixture having between 0.2 and 2.5 parts by weight crosslinker.

7. The formulation of claim 5 wherein the concentration of crosslinker is selected at least in part based on a weather forecast associated with the coal to which the formulation will be applied.

8. A method for reducing coal dust emissions from an exposed surface of coal during transport comprising:
selecting a target application viscosity of a coal topper formulation for the coal, the coal topper formulation containing a polymer at a concentration;
identifying a level of depolymerization for the polymer sufficient to achieve the target application viscosity of the coal topper formulation;
mixing an amount of the selected polymer depolymerized to the level of depolymerization with water to obtain a depolymerized polymer solution; and
applying the depolymerized polymer solution to the exposed surface of coal as a coal topper formulation at about the target application viscosity.

9. The method of claim 8 further comprising:
selecting the target application viscosity based at least in part on one or more of characteristics of the coal and desired penetration of the exposed surface of coal.

10. The method of claim 9 further comprising:
identifying the level of depolymerization based at least in part on the selected polymer and a water usage constraint.

11. The method of claim 8 further comprising:
selecting a depolymerization technique from chemical depolymerization, mechanical depolymerization and energy depolymerization; and
depolymerizing a quantity of the selected polymer to the selected level of depolymerization using the selected depolymerization technique.

12. The method of claim 8 wherein the selected polymer includes one or more of guar gum, carboxymethylated cellulose, starch, and psyllium husk powder.

13. The method of claim 8 further comprising:
selecting an amount of plasticizer based at least in part on a travel characteristic of the coal;
mixing the amount of plasticizer and the amount of the selected polymer depolymerized to the level of depolymerization with water to obtain the depolymerized polymer solution; and
wherein the plasticizer includes one or more of glycerin, polyethylene glycol, fatty acids, and an alcohol.

14. The method of claim 8 further comprising:
selecting an amount of crosslinker based at least in part on an anticipated weather condition;
mixing the amount of crosslinker and the amount of the selected polymer depolymerized to the level of depolymerization with water to obtain the depolymerized polymer solution; and
wherein the crosslinker includes one or more of glyoxal, an aldehyde, potassium pyrantimonate, dimethyl-ol-urea, a borate salt, a zirconium salt, a titanate salt, and a salt of aluminum.

15. A method for reducing dust emissions from a railcar containing coal, the method comprising:
creating a mixture of:
water;
a first amount of depolymerized polymer;
a second amount of plasticizer; and
a third amount of crosslinker.
applying the mixture to coal contained in the railcar when the mixture has a target application viscosity of between about 40 to 140 cps.

16. The method of claim 15 further comprising:
varying the second amount of plasticizer in the mixture based on route information associated with the railcar.

17. The method of claim 15 further comprising:
varying the third amount of crosslinker in the mixture based on weather forecast information associated with the railcar.

18. The method of claim 15 further comprising:
varying the target application viscosity at which the mixture is applied based on an amount of coal fines in the coal.

19. The method of claim 15 further comprising:
identifying the depolymerized polymer, the first amount and the target application viscosity of the mixture; and
selecting a depolymerization level of the depolymerized polymer sufficient to achieve the target application viscosity of the mixture.
